(19) United States
(12) Patent Application Publication
(10) Pub. No.: US 2013/0120979 A1
(43) Pub. Date: May 16, 2013

(54) FLAT CABLE UNIT WITH LIGHT EMITTING ELEMENTS

(71) Applicants: SHAO-KAI CHEN, Taoyuan City (TW); Hsien-Chang Lin, Taoyuan City (TW)

(72) Inventors: SHAO-KAI CHEN, Taoyuan City (TW); Hsien-Chang Lin, Taoyuan City (TW)

(73) Assignee: P-Two Industries Inc., Taoyuan City (TW)

(21) Appl. No.: 13/452,931

(22) Filed: Apr. 23, 2012

(30) Foreign Application Priority Data
Nov. 15, 2011 (TW) 100141776

(51) Int. Cl. F21V 21/00

(52) U.S. Cl. 362/217.17

(57) ABSTRACT

A flat cable unit with light emitting elements includes lower and upper insulating layers, a plurality of metal conductors and light emitting elements. The plurality of metal conductors are disposed in parallel with each other and between the upper and lower insulating layers, and include two power conductors and multiple device conductors. A conductive contact is formed on one end of the power conductor. The device conductors are exposed to openings of the upper insulting layer so as to form a plurality of connecting portions. Each of the power conductors is provided with a linking portion, one end of the linking portion linked to the power conductor, and the other end of the linking portion linked to any one of the device conductors. A plurality of light emitting elements are disposed on the openings and electrically connect the connecting portions.

### BACKGROUND OF THE INVENTION

1. Field of the Invention

The present invention relates to a flexible flat cable structure, and particularly to a flat cable unit with light emitting elements.

2. Related Art

Subject to the rise of the environmental awareness, light-emitting diodes (LEDs) satisfying the requirements for electricity-saving and eco-friendly have been increasingly widely used in electronic products in our daily life, such as Christmas lighting, flashlights, car signal lights, traffic signal lights, cell phones, display devices, and so on. And it is also a trend in the future that light-emitting diodes are to replace traditional lighting elements.

A basic structure of a traditional LED has a transparent insulating body which is provided with different conductive ends having different electrical charges, and a carrying portion. A chip is disposed on the carrying portion, and is surrounded by fluorescent materials formed on the carrying portion. Besides, gold wires are provided to connect an electrode layer of the chip and the conductive ends, and each of the conductive ends extends out of the insulating body to be functioned as a power contact. When the conductive ends are being electrified, the light generated by the chip flows though the fluorescent materials and combine with wavelengths of the fluorescent materials to produce visible light as expected.

Presently, a traditional method to meet the requirements for an electronic product, such as a note book computer, which is in need of partially lighting or indication light, is to provide printed circuits on a printed circuit board or flex circuit board in a keyboard for electrically connecting with the LED so as to light the LED for a purpose of indicating. However, using the printed circuit board or flex circuit board takes a high cost. Furthermore, where to provide the printed circuits has to depend on location of the LED that makes the manufacture complicated and therefore increases the cost.

### SUMMARY OF THE INVENTION

A traditional electrical product utilizing printed circuit boards or flex circuit boards to connect and hold light emitting diodes, but that requires a higher cost of manufacturing.

Accordingly, an object of the present invention is to provide a flat cable unit with light emitting elements, comprising a lower insulating layer, an upper insulating layer, a plurality of metal conductors and a plurality of light emitting elements, wherein the upper insulating layer is disposed on the lower insulating layer, and has a plurality of openings. A plurality of metal conductors is disposed in parallel with each other and between the upper and lower insulating layers. The metal conductors comprises two power conductors and multiple device conductors, at least a conductive contact formed on one end of the power conductors, the device conductors being exposed to the openings so as to form a plurality of connecting portions. Each of the power conductors is provided with a linking portion, one end of the linking portion linked to the power conductor, and the other end of the linking portion linked to any one of the device conductors. A plurality of light emitting elements are disposed on the openings and electrically connect the connecting portions.

The flat cable unit with light emitting elements of the present invention is to utilize a flexible flat cable to replace traditional printed circuit boards or flexible circuit boards, and to utilize the plurality of metal conductors as electrical circuits for the light emitting elements. In this way, the present invention not only simplify the structure of the circuit board with light emitting elements but also economize the manufacturing cost to solve the traditional problem of higher manufacturing cost.

### BRIEF DESCRIPTION OF THE DRAWINGS

FIG. 1 is a schematic top plan view of a flat cable unit with light emitting elements of the present invention before assembling light emitting elements;

FIG. 2 is FIG. 1 after assembling the light emitting elements;

FIG. 3 is a schematic perspective exploded view of FIG. 1;

FIG. 4 is a schematic top plan view of another embodiment of the present invention; and

FIG. 5 is a schematic view showing the flat cable unit of FIG. 1 connecting another flat cable unit.

### DESCRIPTION OF THE PREFERRED EMBODIMENTS

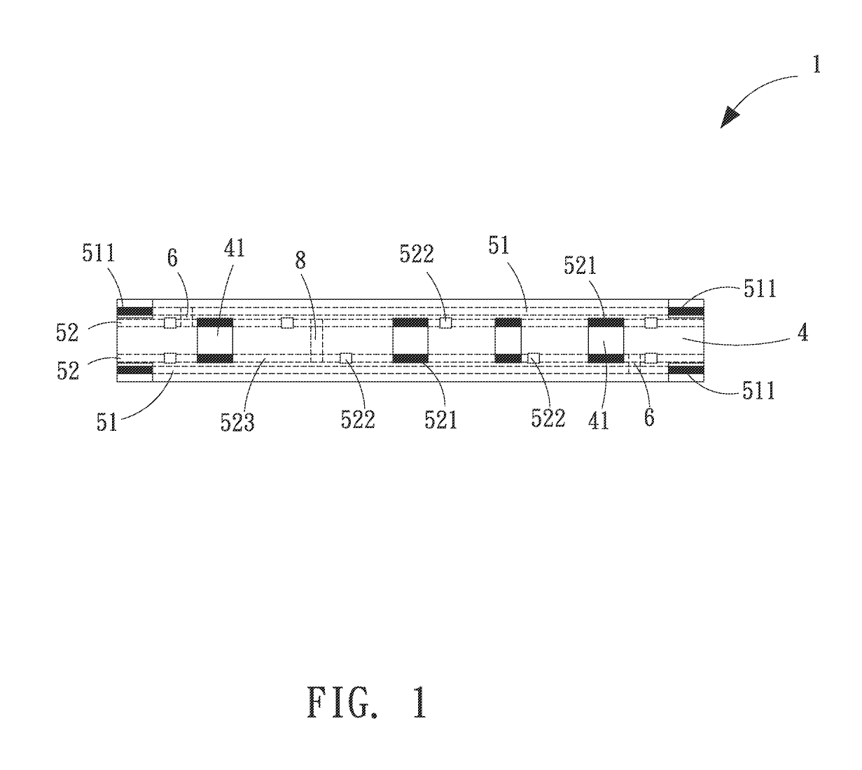

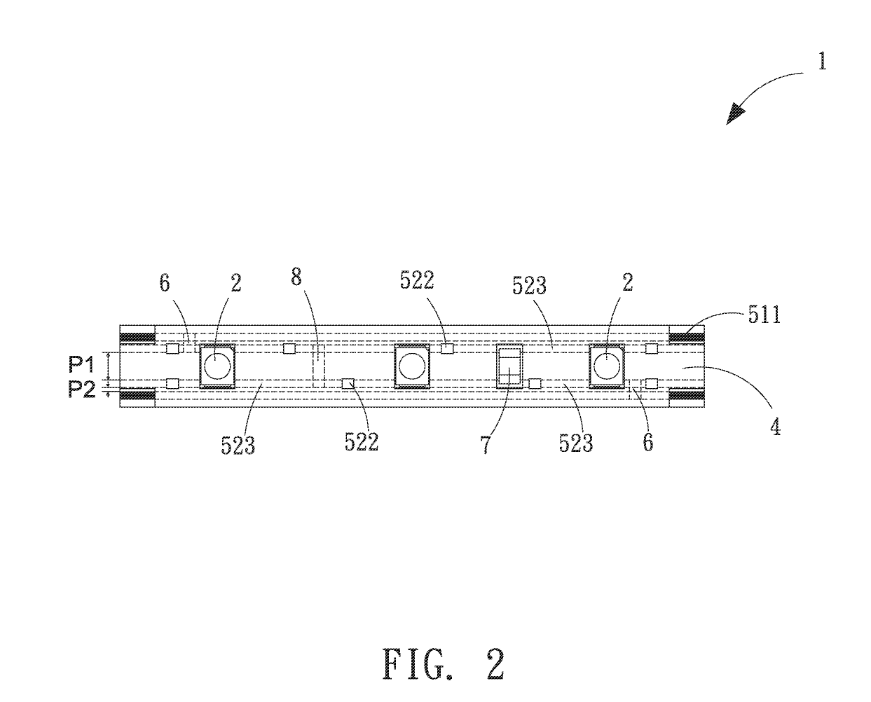

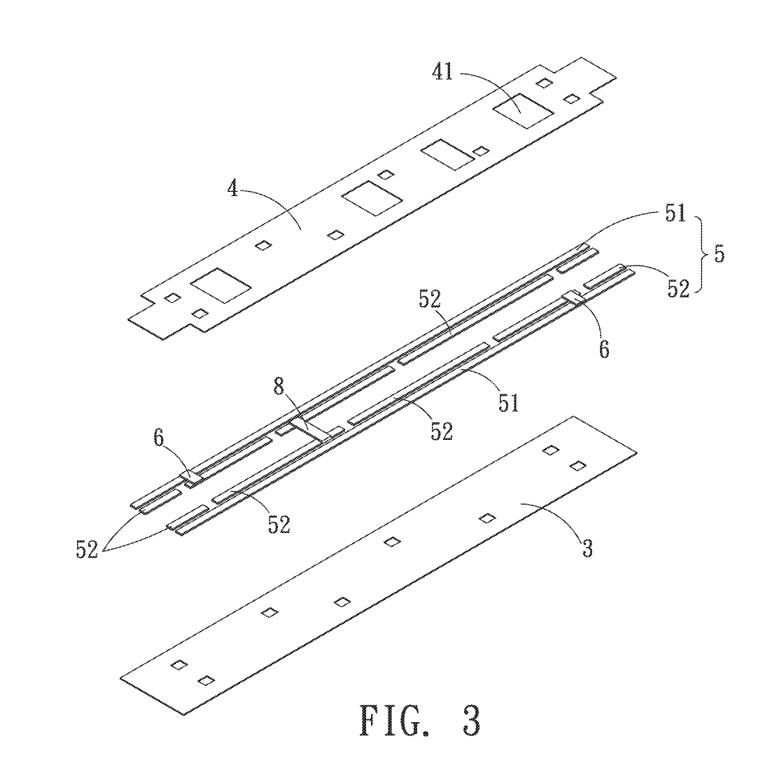

Please refer to FIGS. 1 to 3 showing one of the preferred embodiments of the present invention. The present invention provides a flat cable unit 1 with light emitting elements 2. The flat cable unit 1 is composed of three major layers, a lower insulating layer 3, an upper insulating layer 4 and a plurality of metal conductors 5. The upper insulating layer 4 is disposed on the lower insulating layer 3, the plurality of metal conductors 5 are disposed in parallel with each other and between the upper and lower insulating layers 4, 3. The metal conductors 5 comprise two power conductors 51 at outer sides and two device conductors 52 between the power conductors 51. The ends of power conductors 51 are exposed out of the upper insulating layer 4 so as to form conductive contacts 511. A plurality of openings 41 are disposed on the upper insulating layer 4. The device conductors 52 are exposed to the openings 41 of the upper insulating layer 4 so as to form a plurality of connecting portions 521.

A linking portion 6 is disposed on each of the power conductors 51, with one end of the linking portion 6 linked to the power conductor 51, and the other end of the linking portion 6 linked with the nearest device conductors 52. The linking portions 6 are made from silver paste or other conductive material, and are also disposed between the upper and lower insulating layers 4, 3, same as the plurality of metal conductors 5. The linking portions 6 are located adjacent to two opposite ends of the flat cable unit 1, respectively, and each of the linking portions 6 is disposed closer to the ends of the flat cable unit 1 than the openings 41.

In these embodiments, the ends of the power conductors 51 are exposed out of the upper insulating layer 4 so as to form the conductive contact 511. Each of the two device conductors 52 is provided with a plurality of dividing points 522 so as to divide the device conductor 52 and to form a plurality of segment portions 523. The two ends of the linking portion 6 are linked with the power conductor 51 and the nearest segment portion 523, respectively, whereby the power conductor 51 and the segment portions 523 electrically connect with each other.

The two device conductors 52 of the flat cable unit 1 are intended to electrically connect the plurality of light emitting elements 2 and other components to form a specific light emitting serial circuit. Preferred embodiments of how the light emitting elements 2 and other components are arranged on the device conductors 52 are as follows:

The three light emitting elements 2 are disposed apart from each other on the two device conductors 52 parallel with each other. Each of the light emitting elements 2 is disposed on the opening 41 and electrically connects the connecting portions 521, respectively, wherein each of the plurality of light emitting elements 2 connects with two of the segment portions 523 being parallel with each other. Each of the segment portions 523 is connected with one end of only one of the light emitting element 2. Therefore, the plurality of light emitting elements 2 and the corresponding segment portions 523 electrically connect with each other and cooperatively form an electrical circuit.

A passive component 7 is disposed on the two device conductors 52 corresponding and parallel with each other, wherein the passive component 7 is disposed between any two of the light emitting elements 2, two opposite ends of the passive component 7 are connected to two corresponding segment portions 523 being parallel with each other, respectively. In this embodiment, the passive component 7 is a current-limiting resistance intended for protecting the light emitting elements 2 from being shorten the lifespan by large current.

A coupling portion 8 is disposed on the two device conductors 52 being parallel with each other. Two opposite ends of the coupling portion 8 are coupled to two corresponding segment portions 523 being parallel with each other, respectively. The coupling portion 8 is disposed between the upper insulating layers 4 and lower insulating layers 3 and between any two of the light emitting elements 2 correspondingly. The passive component 7 is apart from the coupling portion 8 with one of the light emitting elements 2 in between. The coupling portion 8 is connected in series with the passive component 7 and the three light emitting elements 2 to form an electrical circuit, and directions of the positive and negative electrodes of the three parallel light emitting elements 2 are in consistent with each other by disposing the coupling portion 8, so as to facilitate the light emitting elements 2 soldered to the connecting portions 521.

In this embodiment, the flat cable unit 1 has two device conductors 52, three light emitting elements 2, one passive component 7, and one coupling portion 8. The number and distribution of the light emitting elements 2 and the passive component 7 are set according to the volume of voltage of applied products.

Besides, a distance between the two device conductors 52 is set according to the size of the light emitting element 2, so a first pitch P1 between the two device conductors 52 is larger than a second pitch P2 between the power conductor 51 and the device conductors 52. Particularly, there are no other device conductors 52 provided between the two device conductors 52 of the present invention, but the invention is not limited thereby. Other device conductors 52 can also be added to form different circuit layouts. Alternatively, the two power conductors 51 can be disposed between the two device conductors 52.

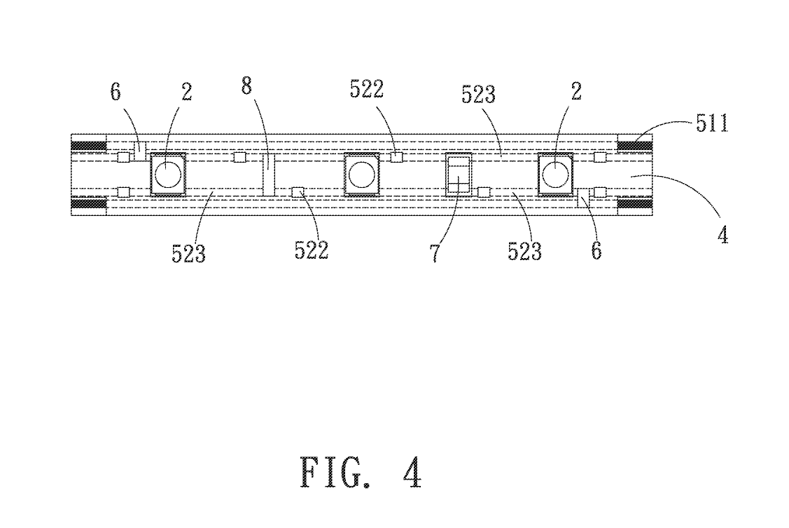

In this embodiment, the linking portions 6 and the coupling portion 8 are a conductive structure made by spreading silver paste on and then drying the linking portions 6 and the coupling portion 8. Furthermore, the linking portions 6 and the coupling portion 8 are disposed between the upper and lower insulating layers 4, 3, but is not limited thereby. Alternatively, as another embodiment shown in FIG. 4, the linking portions 6 and the coupling portion 8 can be disposed directly on the upper insulating layer 4, and made by spreading silver paste, or can be selected by other conductive components. Conductive components, just like the light emitting elements 2 and the passive component 7, are soldered to the metal conductors 5 after openings are formed appropriately on the upper insulating layer 4.

With the power conductors 51, the flat cable unit 1 with the light emitting elements 2 of the present invention becomes an individual unit and is extendable with other flat cable unit. When multiple flat cable units 1 are electrically connected with one another, malfunction of one of the connected flat cable units 1 is not to affect operation of the rest of others. Besides, the number of how many flat cable units 1 are about to be connected can depend on the volume of source power so as to achieve better efficiency of power usage.

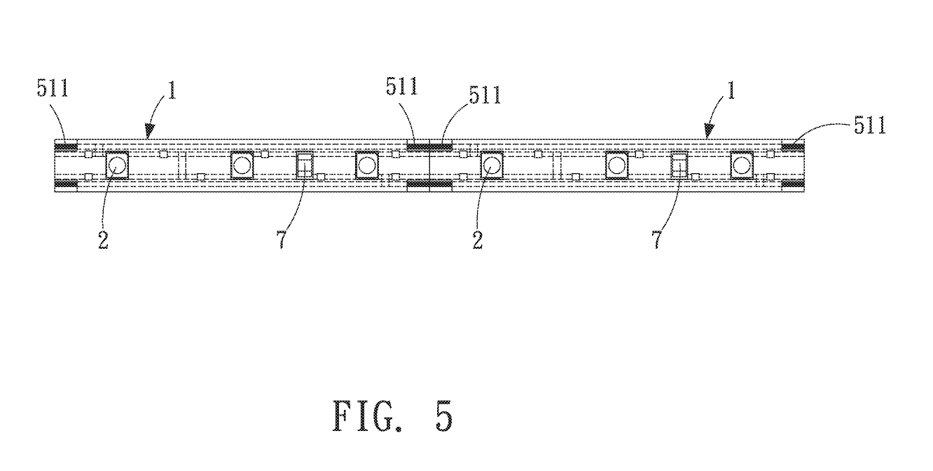

Referring to FIG. 5 showing a schematic view of the flat cable unit 1 of the present invention being connected to another flat cable unit 1, the two flat cable units 1 have the same structure. Each flat cable unit 1 is connectable with the other flat cable unit 1 by the conductive contacts 511 at ends thereof, so as to form a flat cable unit 1 that is provided with the plurality of light emitting elements 2 and is extended repeatedly. Besides, the plurality of flat cable units 1 is capable of being manufactured continuously and packed one by one to be a flat cable strip. According to actual applications, Users can take a proper number of the flat cable units 1 from the flat cable strip as desired to use, or cut the flat cable strip into the flat cable units individually to use. Accordingly, the flat cable unit of the present invention is beneficial to mass production, so as to allow users to easily take proper number of the flat cable units 1 from a roll of the flat cable strip.

Accordingly, the flat cable unit with light emitting elements of the present invention is to utilize a flexible flat cable to replace traditional printed circuit boards or flexible circuit boards, and utilize the plurality of metal conductors on the flexible flat cable as electrical circuits for the light emitting elements. In this way, the present invention not only simplify the structure of the circuit board with light emitting elements but also economize the manufacturing cost to solve the traditional problem of higher manufacturing cost . Besides, the metal conductors of the flat cable unit are provided with two power conductors for connecting and transferring power, and the two power conductors are connectable with another flat cable unit in order to extend a length of the flat cable unit, whereby to successfully achieve the purposes of effectively using power and convenient use.

It is understood that the invention may be embodied in other forms within the scope of the claims. Thus the present examples and embodiments are to be considered in all respects as illustrative, and not restrictive, of the invention defined by the claims.

What is claimed is:

1. A flat cable unit with light emitting elements, comprising:
a lower insulating layer;
an upper insulating layer disposed on the lower insulating layer, and having a plurality of openings;
a plurality of metal conductors disposed in parallel with each other and between the upper and lower insulating layers, the metal conductors comprising two power conductors and multiple device conductors, at least a conductive contact formed on one end of the power conductor, the device conductors being exposed to the openings so as to form a plurality of connecting portions, a linking portion being disposed on each of the power conductors, with one end of the linking portion linked to the power conductor, and the other end of the linking portion linked to any one of the device conductors; and
the plurality of light emitting elements disposed on the openings and electrically connecting the connecting portions, respectively.

2. The flat cable unit with the light emitting elements of claim 1, wherein the linking portions are located adjacent to two opposite ends of the flat cable, respectively, and each of the linking portions is disposed between the openings and the ends of the flat cable.

3. The flat cable unit with the light emitting elements of claim 1, wherein the device conductors are disposed between the two power conductors, and two ends of the power conductors are exposed out of the upper insulating layer so as to form the conductive contact.

4. The flat cable unit with the light emitting elements of claim 1, wherein the linking portion is disposed between the upper and lower insulating layers, with one end thereof linked to the nearest device conductor.

5. The flat cable unit with the light emitting elements of claim 1, wherein the linking portion is disposed on the upper insulating layer, with one end thereof linked to the nearest device conductor.

6. The flat cable unit with the light emitting elements of claim 1, wherein a number of the multiple device conductors is two, each of the two device conductors is provided with a plurality of dividing points so as to divide the device conductor and to form a plurality of segment portions, the two ends of the linking portion are linked with the power conductor and any one of the segment portions, respectively, whereby the power conductor and any one of the segment portions electrically connect with each other, and each of the plurality of light emitting elements connects with two of the segment portions being parallel with each other.

7. The flat cable unit with the light emitting elements of claim 6, further comprising a coupling portion being disposed between any two of the light emitting elements, and two opposite ends of the coupling portion are coupled to two corresponding segment portions being parallel with each other, respectively.

8. The flat cable unit with the light emitting elements of claim 7, further comprising a passive component, two opposite ends of the passive component are connected to two corresponding segment portions being parallel with each other, respectively, a number of the light emitting elements is three, and the three light emitting elements are disposed apart from each other on the two device conductors.

9. The flat cable unit with the light emitting elements of claim 1, wherein a first pitch is defined by the two device conductors, a second pitch is defined by one of the device conductors and the power conductor nearest to the one of the device conductors, and the first pitch is larger than the second pitch.

10. The flat cable unit with the light emitting elements of claim 1, wherein the conductive contact of the flat cable unit electrically connects with the conductive contact of another flat cable so as to extend a length of the flat cable.
